(19) United States
(12) Patent Application Publication
(10) Pub. No.: US 2024/0175299 A1
(43) Pub. Date: May 30, 2024

(54) DOOR OPENING AND CLOSING APPARATUS FOR PREVENTION OF DOOR OPENING DURING COLLISION

(71) Applicants: Hyundai Motor Company, Seoul (KR); Kia Corporation, Seoul (KR)

(72) Inventor: Dae-Young CHOI, Gunpo-Si (KR)

(73) Assignees: Hyundai Motor Company, Seoul (KR); Kia Corporation, Seoul (KR)

(21) Appl. No.: 18/520,920

(22) Filed: Nov. 28, 2023

(30) Foreign Application Priority Data
Nov. 30, 2022 (KR) 10-2022-0163992
Oct. 11, 2023 (KR) 10-2023-0135394

(51) Int. Cl. E05B 77/06

(52) U.S. Cl. CPC E05B 77/06

(57) ABSTRACT

A door opening and closing apparatus for a vehicle that prevents door opening during a collision includes an operation member configured to operate to open a door; and a blocking lever engaged to the operation member and configured to limit the operating of the operation member during a collision of a vehicle, wherein the blocking lever includes an operation slot formed along a tracking path along which a linkage member operating the operation member and the blocking lever by linkage to each other is moved from a locking position to an unlocking position; and a blocking slot formed to branch off from the operation slot, wherein during the collision of the vehicle, the blocking lever is rotated or moved, and thus the linkage member is moved from the operation slot to the blocking slot, being blocked from reaching the unlocking position.

### CROSS-REFERENCE TO RELATED APPLICATION

The present application claims priority to Korean Patent Application No. 10-2022-0163992, filed on Nov. 30, 2022 and 10-2023-0135394, filed on Oct. 11, 2023, the entire contents of which is incorporated herein for all purposes by this reference.

### BACKGROUND OF THE PRESENT DISCLOSURE

### Field of the Present Disclosure

The present disclosure relates to a door opening and closing apparatus for a vehicle that prevents a door from opening during a collision, and more particularly to a door opening and closing apparatus which includes a blocking lever that prevents a door from being opened due to collision energy applied thereto by blocking the door opening and closing apparatus from being operated during a collision of a vehicle.

### Description of Related Art

A door through which an occupant rides in a vehicle or gets out of the vehicle is provided on one side of the vehicle.

A door latch that holds the door securely on a body of the vehicle or unlocks the door, a handle that an occupant manipulates to operate the door latch, and the like are provided on one side of the door. When the occupant operates the handle from the inside of the vehicle or from the outside thereof to ride in the vehicle or get out of the vehicle, an operation force of the handle is transferred to the door latch, and thus the door is unlocked, keeping the door openable. Furthermore, when the door is closed, the door latch keeps the door stationary to the body of the vehicle.

One of vehicle safety regulations requires that the door latch keeps the door locked during a collision of a vehicle (particularly, during a side collision of the vehicle), to prevent the occupant from being forced to be pushed out of the vehicle during the collision of the vehicle.

For example, in a case where a balance weight is mounted on one side of the door handle and where a collision occurs, the balance weight blocks the handle from being operated. Thus, the door latch keeps the door locked, preventing the door from being opened. That is, when a collision occurs, the balance weight is configured to offset inertial energy acted to the handle due to the collision, preventing the handle from being raised due to collision. Because the handle is not raised, the door opening and closing apparatus, such as the door latch, may not be operated, preventing the door from being opened.

However, in an actual collision situation, it is difficult to predict whether sufficient inertial energy is acted to the balance weight. Moreover, due to the tightened regulation, there occurs a problem in that volume and weight of the balance weight may be increased.

Furthermore, the increase in the volume of the balance weight causes a layout restriction in designing the door, and the increase in the weight thereof causes a decrease in fuel efficiency.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a door opening and closing apparatus for a vehicle that includes a blocking lever preventing a door from opening during a collision, the apparatus which operates at a high speed due to a collision, one side of which is thus securely held by the blocking lever, keeping the door in a closed state during the collision.

To accomplish the above-mentioned object, according to an aspect of the present disclosure, there is provided a door opening and closing apparatus for a vehicle that includes a blocking lever preventing door opening during a collision, the apparatus may include: an operation member configured to operate to open a door: and a blocking lever engaged to the operation member and configured to limit the operating of the operation member during a collision of a vehicle, wherein the blocking lever includes: an operation slot formed along a tracking path along which a linkage member operating the operation member and the blocking lever by linkage to each other is moved from a locking position to an unlocking position: and a blocking slot formed to branch off from the operation slot, and wherein in response to the collision of the vehicle, the blocking lever is rotated or moved, and thus the linkage member is moved from the operation slot to the blocking slot, being blocked from reaching the unlocking position.

In the door opening and closing apparatus, the blocking slot may be formed so that a distance of the blocking lever from the operation slot is increased toward a first side of the blocking lever from a second side of the blocking lever which is hinged to a housing.

In the door opening and closing, the blocking slot may be formed so that an imaginary central axis of the blocking slot is inclined with respect to an imaginary central axis of the operation slot.

In the door opening and closing apparatus, the blocking slot may be formed so that extends from the operation slot in a direction that moves away therefrom transversely to a rotation direction or a moving direction of the blocking lever.

In the door opening and closing apparatus, the blocking slot branches off from the operation slot so that the blocking slot is positioned behind the operation slot in a situation that the blocking lever is rotated or moved.

In the door opening and closing apparatus, a protrusion portion may be formed at a position at which the blocking slot branches off from the operation slot, so that the protrusion portion protrudes toward the blocking slot.

In the door opening and closing apparatus, the protrusion portion may be formed on another internal surface of the operation slot that faces an internal surface of the operation slot in which the blocking slot is formed.

In the door opening and closing apparatus, the protrusion portion may be formed so that the protrusion portion is brought into contact with the linkage member in a situation that the linkage member reaches a branching position at which the blocking slot branches off from the operation slot.

In the door opening and closing apparatus, the protrusion portion may be formed so that a distance from the protrusion portion to an end portion of the blocking slot is shorter than a distance from the protrusion portion to an end portion of the operation slot.

In the door opening and closing apparatus, an inclination portion may be formed on the protrusion portion, the linkage member being moved along the inclination portion from the operation slot to the blocking slot in a situation that the blocking lever is rotated or is moved due to the collision of the vehicle.

In the door opening and closing apparatus, the inclination portion may be formed in an inclined manner so that, in a situation that the blocking lever is rotated or is moved, the inclination portion may be positioned farther and farther from an internal surface of the operation slot, on which the protrusion portion is formed, along a direction in which the linkage member is moved.

In the door opening and closing apparatus, the inclination portion may be formed in parallel with the imaginary central axis line of the blocking slot.

In the door opening and closing apparatus, the inclination portion may be formed so that lies on the same line as an imaginary extension line or such which is positioned closer to one side of the blocking lever which is hinged to the housing than the imaginary extension line, the imaginary extension line extending from an internal surface, one of internal surfaces of the blocking slot, which supports the linkage member which is moved into the blocking slot.

In the door opening and closing apparatus, a guiding portion may be formed on the protrusion portion, the guiding portion guiding the linkage member to a remaining section of the operation slot after the linkage member is moved along the inclination portion to the end portion of the inclination.

In the door opening and closing apparatus, the protrusion portion is formed so that a distance between a top portion of the protrusion portion and a portion of an internal surface that meets the operation slot is greater than a diameter of the linkage member, the internal surface being one of internal surfaces of the blocking slot and supporting the linkage member which is moved into the blocking slot.

In the door opening and closing apparatus, the operation slot may be formed along a tracking path along which the linkage member is moved during normal operation of the door opening and closing apparatus.

In the door opening and closing apparatus, a hinge connection hole for hinge-connecting the blocking lever to the door opening and closing apparatus may be formed in one side of the blocking lever, and the operation slot may be formed to extend toward the other side of the blocking lever from a position which is spaced a predetermined distance apart away from the hinge connection hole.

The door opening and closing apparatus may be a door handle assembly in which a door handle lever causes a door handle to pop up from the housing, the operation member may be the door handle, and the linkage member may be the door handle lever.

In the door opening and closing apparatus, the blocking lever may be provided rotatably or movably on the housing, and the door handle lever may be provided to pass through the operation slot.

In the door opening and closing apparatus, during the collision of the vehicle, the door handle lever is moved along the operation slot and is moved from the operation slot to the blocking slot, blocking the door handle from completely being popped upwards.

The door opening and closing apparatus according to another exemplary embodiment of the present disclosure may be a door latch which is provided on one side of a door and holds a striker securely, the operation member may be a release lever that releases a claw and a pole of the door latch, and the linkage member may be a linkage pin which is formed on the release lever so that protrudes therefrom.

In the door opening and closing apparatus according to another exemplary embodiment of the present disclosure, the blocking lever may be rotatably provided on one side of the door latch, and the linkage pin may be provided to pass through the operation slot.

In the door opening and closing apparatus according to another exemplary embodiment of the present disclosure, during the collision of the vehicle, the linkage pin may be moved along the operation slot so that the release lever does not unlock the claw and the pole, and may be moved from the operation slot to the blocking slot, blocking the release lever from being rotated.

The door opening and closing apparatus according to various exemplary embodiments of the present disclosure may be a door handle which is provided on a housing such which is rotatable about a rotation shaft, and the linkage member may be a linkage protrusion which is formed on one side of the door handle.

The door opening and closing apparatus according to still further embodiment of the present disclosure may be a door inside handle which is rotatably provided on a door trim, and the linkage member may be a linkage protrusion which is formed on one side of the door inside handle.

With the vehicle door opening and closing apparatus for a vehicle that includes a blocking lever preventing door opening during a collision, which is configured as described, a phenomenon where the door is opened during the collision may be prevented with a simple structure by changing a tracking path, along which one side of the door opening and closing apparatus operates, using a speed at which a handle is raised during the collision or a speed at which the door latch operates during the collision.

The door may be prevented from being opened during the collision, using the blocking lever instead of using a balance weight. Therefore, although a regulation is tightened, and thus, an operation condition is changed, the regulation may be easily satisfied by changing a shape of the slot formed inside the blocking lever and changing a shape and a position of the protrusion portion.

Furthermore, although the shape of the protrusion portion is changed to satisfy the changed operation condition, the weight of the vehicle door opening and closing apparatus for a vehicle is not increased. Thus, a phenomenon where fuel efficiency is reduced or where a layout in designing the door is more restricted may be prevented.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is an explosive perspective view exemplarily illustrating a state where a blocking lever according to an exemplary embodiment of the present disclosure that prevents door opening during a collision is provided on a door handle assembly.

FIG. 2 is a plan view exemplarily illustrating the blocking lever according to an exemplary embodiment of the present disclosure that prevents the door opening during the collision.

FIG. 3 is an enlarged view exemplarily illustrating a portion B, which is indicated by a rectangular broken line in FIG. 2.

FIG. 4 is a plan view exemplarily illustrating a tracking path along which, during normal operation, a door handle lever is moved inside the blocking lever according to an exemplary embodiment of the present disclosure that prevents the door opening during the collision.

FIG. 5A, FIG. 5B, FIG. 5C, and FIG. 5D are plan views sequentially illustrating steps in which, during normal operation, the door handle lever is moved inside the blocking lever according to an exemplary embodiment of the present disclosure that prevents the door opening during the collision.

FIG. 6 is a schematic view exemplarily illustrating sequential processes in which, during normal operation, a door handle on which the blocking lever according to an exemplary embodiment of the present disclosure that prevents the door opening during the collision is mounted and the door handle lever operates.

FIG. 7 is a plan view exemplarily illustrating a tracking path along which the door handle lever is moved inside the blocking lever according to an exemplary embodiment of the present disclosure that prevents the door opening during the collision.

FIG. 8A, FIG. 8B, FIG. 8C, and FIG. 8D are plan views exemplarily illustrating the blocking lever according to an exemplary embodiment of the present disclosure that prevents the door opening during the collision and sequentially illustrating steps in which the door handle lever is moved inside the blocking lever during the collision.

FIG. 9 is a schematic view exemplarily illustrating a process in which a door handle on which the blocking lever according to an exemplary embodiment of the present disclosure that prevents the door opening during the collision is mounted and the door handle lever operate during the collision.

FIG. 10 is a plan view exemplarily illustrating a blocking lever according to another exemplary embodiment of the present disclosure that prevents the door opening during the collision.

FIG. 11 is a plan view exemplarily illustrating a blocking lever according to various exemplary embodiments of the present disclosure that prevents the door opening during the collision.

FIG. 12 is a schematic view exemplarily illustrating a state where the blocking lever of FIG. 11 is mounted on a rotation-type door handle.

FIG. 13 is a schematic view exemplarily illustrating a state where the blocking lever of FIG. 11 is mounted on a door internal handle.

FIG. 14 is a schematic view exemplarily illustrating a state where the blocking lever of FIG. 11 is mounted on a door latch.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

A door opening and closing apparatus for a vehicle that includes a blocking lever preventing door opening during a collision according to an exemplary embodiment of the present disclosure will be described in detail below with reference to the accompanying drawings.

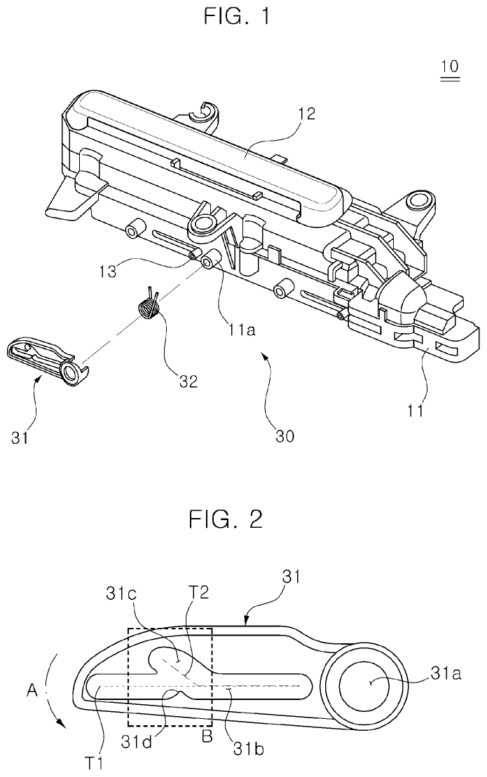

FIG. 1 is an explosive perspective view exemplarily illustrating a state where a blocking lever 31 of an opening and closing apparatus 30 according to an exemplary embodiment of the present disclosure that prevents door opening during a collision is provided on a door handle assembly 10.

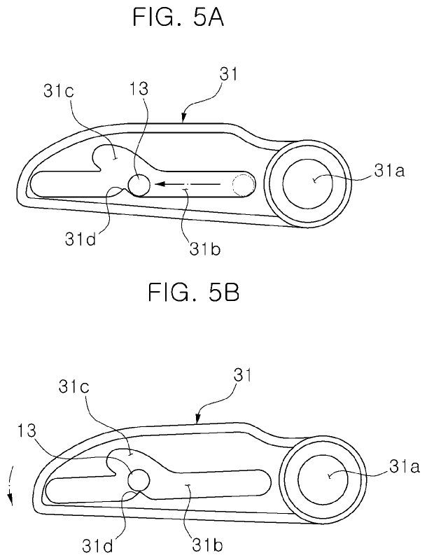

According to an exemplary embodiment of the present disclosure, the door opening and closing apparatus 30 may include an operation member 12 that operates to open a door and a blocking lever 31 that limits the operating of the operation member 12 during a collision of a vehicle, the blocking lever 31 includes an operation slot 31b which is formed along a tracking path along which a linkage member 13 operating the operation member 12 and the blocking lever 31 by linkage to each other is moved from a locking position D0 to an unlocking position D2 (See FIG. 4), and a blocking slot 31c which is formed to branch off from the operation slot 31b. During the collision of the vehicle, the blocking lever 31 is rotated or moved, and thus the linkage member 13 is moved from the operation slot 31b to the blocking slot 31c due to a collision energy, being blocked from reaching the unlocking position D2.

The blocking lever 31 may be provided rotatably or movably on one side of the door opening and closing apparatus 30 provided on any one of a vehicle door and a vehicle body. When the vehicle collision occurs, while being rotated or moved faster than during normal operation of the door opening and closing apparatus 30, the blocking lever 31 may interrupt operation of the door opening and closing apparatus 30. Accordingly, during the collision, the door opening and closing apparatus 30 may not be caused to be unlocked, and thus the door may be prevented from being opened.

In an exemplary embodiment of the present disclosure, an example where the blocking lever 31 may be provided on a door handle assembly 10 that an occupant operates from the outside of the vehicle to ride in the vehicle is described.

The door handle assembly 10 may include a housing 11, a door handle (or the operating member) 12 which is provided on the housing 11 such which is enabled to pop up, and a door handle lever 13 (or the linkage member) that causes the door handle 12 to pop up from the housing 11. When the door handle lever 13 rotates and thus the door handle 12 pops up by a predetermined height from the housing 11, the occupant may open the door by pulling up the door handle 12.

The blocking lever 31 may be provided rotatably or movably on one side of the door handle assembly 10. A hinge connection hole 31a may be formed in one side of the blocking lever 31, and a hinge pin 11a may be formed on the housing 11. Thus, the blocking lever 31 may be rotatably provided on the door handle assembly 10. When the blocking lever 31 may be rotatably provided on the housing 11, a torsion spring 32 may be mounted between the housing 11 and the blocking lever 31 to applying an elastic force to return the blocking lever 31 to an original position thereof.

The blocking lever 31 which is rotatably provided on one side of the door handle assembly 10 is mainly described hereinafter. However, the blocking lever 31 may be movably provided on one side of the door handle assembly 10.

The operation member 12 may be formed as the door handle 12, and the linkage member 13 may be formed as the door handle lever 13 that operates the door handle 12 and the blocking lever 31 together by linkages to each other.

In a state where the blocking lever 31 is rotatably provided, a rotation speed of the blocking lever 31 may vary according to an amount of impact force applied to the door handle assembly 10 during a collision. The rotation speed of the blocking lever 31 may be increased more during the collision of the vehicle than during normal operation of the door handle assembly 10. This increase in the rotation speed of the blocking lever 31 may interrupt operation of the blocking lever 31 and operation of the door handle lever 13, and thus, the door opening and closing apparatus 30 may not be caused to be unlocked. In a case where the blocking lever 31 is movably provided, a moving speed of the blocking lever 31 may be increased more during the collision of the vehicle than during the normal operation of the door handle assembly 10, interrupting the operation of the blocking lever 31 and the operation of the door handle lever 13.

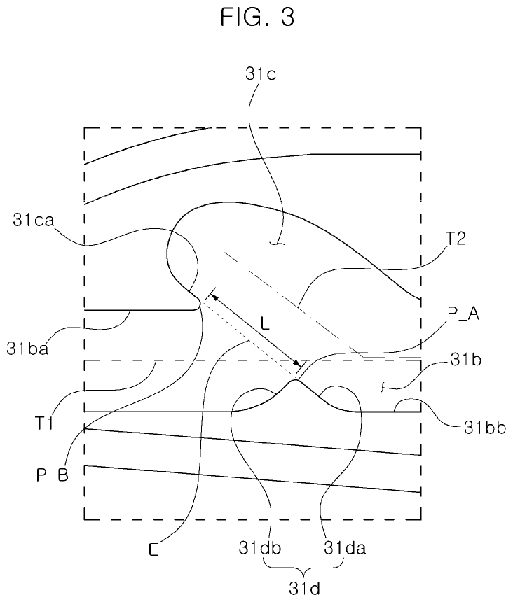

FIG. 2 illustrates an example of the blocking lever 31. The blocking lever 31 may include the above-described hinge connection hole 31a, the operation slot 31b, and the blocking slot 31c in one side thereof. The operation slot 31b may be formed along the tracking path along which the door handle lever 13 is moved from the locking position DO and the unlocking position D2 when the occupant operates the door handle assembly 10. The blocking slot 31c may be formed to branch off from the operation slot 31b.

The operation slot 31b may be formed inside the blocking lever 31 along a first tracking path T1 which is a tracking path along which the door handle lever 13 is moved during normal operation. In the door handle assembly 10, the door handle lever 13 is moved in a straight line within a predetermined section. For the present reason, the operation slot 31b may be formed so that also extends along a straight line. That is, the operation slot 31b may extend toward the other side of the blocking lever 31 from a position which is spaced a predetermined distance apart away from the hinge connection hole 31a in the blocking lever 31. For the present reason, the operation slot 31b may be formed so that extends in a straight line along the first tracking path T1 along which the door handle lever 13 is moved.

The blocking slot 31c may be formed so that branches off from the operation slot 31b. Accordingly, the blocking slot 31c may be formed so that a distance thereof from the operation slot 31b is increased toward the other end portion of the blocking lever 31. The block slot 31c may be formed so that the block slot 31c extends from the operation slot 31b toward a direction that moves away therefrom transversely to a rotation direction or a moving direction of the blocking lever 31. That is, the block slot 31c may be formed so that an imaginary central axis of the blocking slot 31c is moved away from the operation slot 31b transversely to a circular tracking path which is formed by the other end portion of the blocking lever 31 while the blocking lever 31 is rotated. For example, as illustrated in FIG. 2, the block slot 31c may be formed so that when the blocking lever 31 is rotated counterclockwise, the blocking slot 31c may face leftward and upward.

The blocking slot 31c may form a second tracking path T2 which is a tracking path along which the door handle lever 13 is moved during the collision. In a case where collision energy is acted to the door handle assembly 10 due to the collision of the vehicle and thus the blocking lever 31 is rotated, the door handle lever 13 may be moved from the operation slot 31b to the blocking slot 31c.

The blocking slot 31c may branch off from the operation slot 31b so that the blocking slot 31c is positioned behind the operation slot 31b when the blocking lever 31 is rotated. That is, as illustrated in FIGS. 2 to 9, the other end portion of the blocking lever 31 may be rotated counterclockwise (i.e., in a direction of an arrow an in FIG. 2) about the hinge connection hole 31a. For the present reason, as illustrated, the blocking slot 31c may branch off from the operation slot 31b to extend upwards. The imaginary central axis in a large dotted line of the blocking slot 31c may be formed such which is inclined at a predetermined angle with respect to the imaginary central axis in a small dotted line of the operation slot 31b. FIG. 2 illustrates that the second tracking path T2 is inclined with the respect to the first tracking path T1.

The blocking slot 31c may be formed to include a shorter length than the operation slot 31b. That is, the blocking slot 31c may be formed so that a length of the blocking slot 31c from a point on the blocking slot 31c at which the blocking slot 31c branches off from the operation slot 31b to an end portion of the blocking slot 31c may be shorter than a length of the operation slot 31b from one end portion thereof to the other end portion thereof. Because the blocking slot 31c is formed to include a shorter length, the door handle lever 13 may reach a blocking position D3 which is positioned closer to the locking position D0 than the unlocking position D2 at which an operation is completely performed in the housing 11. The door handle lever 13 may be moved upwards to only the blocking position D3 without reaching the unlocking position D2. Because of this, the door handle assembly 10 may be kept locked without being arbitrarily unlocked.

A protrusion portion 31d may be formed on the operation slot 31b. The protrusion portion 31d may be formed at a position at which the blocking slot 31c branches off from the operation slot 31b. Thus, the door handle lever 13 may be caused to be easily moved into the blocking slot 31c. That is, the protrusion portion 31d may be formed so that the protrusion portion 31d is brought into contact with the linkage member 13 when the linkage member reaches a branching position D1 at which the blocking slot 31c branches off from the operation slot 31b.

During normal operation, even when the door handle lever 13 reaches the branching position D1 and is caught by the protrusion portion 31d, the door handle lever 13 may be moved over the protrusion portion 31d and is moved upwards to the remaining section of the operation slot 31b, that is, is moved from the branching position D1 to the unlocking position D2 as shown in FIG. 4. However, during the collision, the door handle lever 13 may be interrupted by the protrusion portion 31d, and after that the door handle lever 13 may be moved to the blocking slot 31c.

The protrusion portion 31d may be formed on an internal surface 31bb of the operation slot 31b that faces an internal surface 31ba of the operation slot 31b in which the blocking slot 31c is formed. That is, the protrusion portion 31d may be formed on the internal surface 31bb, one of internal surfaces of the operation slot 31b, in which the blocking slot 31c is not formed.

An inclination portion 31da may be formed on the protrusion portion 31d. When the linkage member 13 reaches the branching position D1, the linkage member 13 may be moved along the inclination portion 31da from the operation slot 31b to the blocking slot 31c.

The inclination portion 31da may be formed in an inclined manner so that the inclination portion 31da is positioned farther and farther from the internal surface 31bb of the operation slot 31b, on which the protrusion portion 31d is formed, along a direction in which the linkage member 13 is moved.

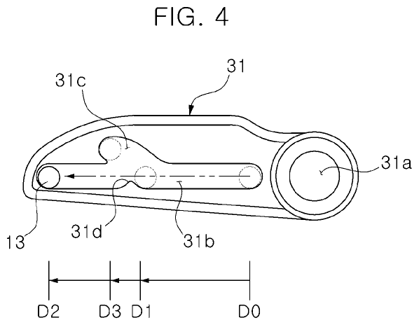

The inclination portion 31da may be formed in parallel with the imaginary central axial line of the blocking slot 31c. Moreover, the inclination portion 31da may be formed so that lies on the same line as a communicating portion E. The imaginary line of communicating portion E extends from an internal surface 31ca, one of internal surfaces of the blocking slot 31c, which supports the linkage member 13 which is moved into the blocking slot 31c. FIG. 3 illustrates that the imaginary line of communicating portion E lies on the same line as the inclination portion 31d Alternatively, the inclination portion 31d may be formed such that the inclination portion 31d is positioned closer to the hinge connection hole 31a than the communicating portion E. For example, as in FIG. 3, the inclination portion 31da may also be positioned more rightward than the communicating portion E.

When the linkage member 13 reaches the branching portion D1 by the inclination portion 31da, if the door handle lever 13 is in normal operation, the linkage member 13 may be moved along the inclination portion 31da at a low speed, may be moved over the protrusion portion 31d, and then may be moved through the communicating portion E to the remaining section of the operation slot 31b. However, during the collision of the vehicle, the linkage member may be moved along the inclination portion 31da at a high speed and may be moved into the blocking slot 31c.

A guiding portion 31db may be formed on the protrusion portion 31d. The guiding portion 31db guides the linkage member 13 to the remaining section of the operation slot 31b after the linkage member 13 is moved through the communicating portion E and along the inclination portion 31da to the end portion of the inclination. The guiding portion 31db is concavely formed and connected to the inclination portion 31da. Thus, the linkage member 13, which is moved along the communicating portion E and the inclination portion 31da to the end portion of the inclination by the guiding portion 31db, may be smoothly moved to the internal surface 31bb of the operation slot 31b.

The protrusion 31d may be formed so that a distance L of the communicating portion E between the top portion P_A of the protrusion portion 31d and a portion P-B of the internal surface 31_{ca} meets the operation slot 31b may be greater than a diameter d of the linkage member. The internal surface 31ca may be one of the internal surfaces of the blocking slot 31c and may support the linkage member 13 which is moved into the blocking slot 31c. The reason for this is to enable the linkage member 13 to be moved over the protrusion portion 31d and then to be easily moved into the remaining section of the operation slot 31b after moving through the communicating portion E.

The protrusion portion 31d may be formed so that a distance from the protrusion portion 31d to an end portion of the blocking slot 31c is shorter than a distance from the protrusion portion 31d to an end portion of the operation slot 31b. Thus, the blocking slot 31c may be formed to include a shorter length than the operation slot 31b.

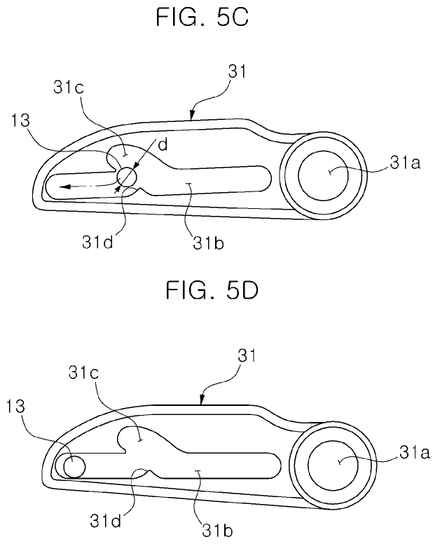

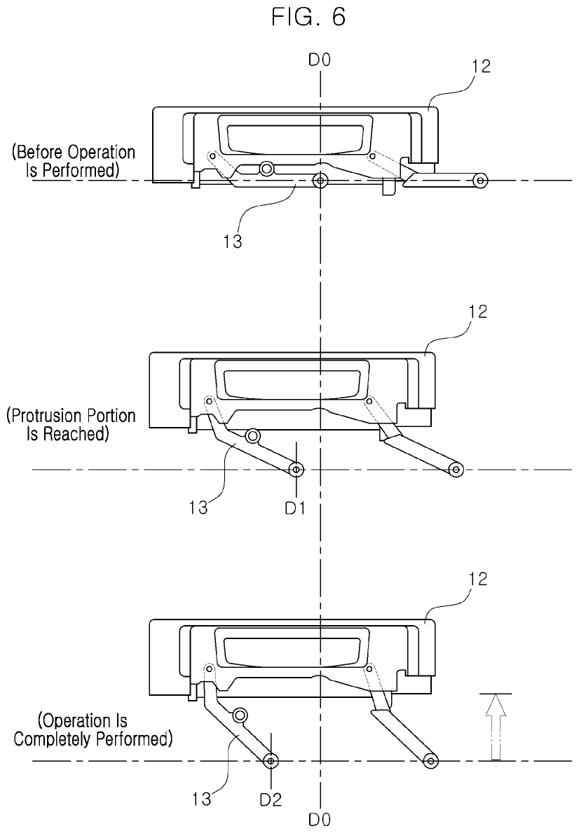

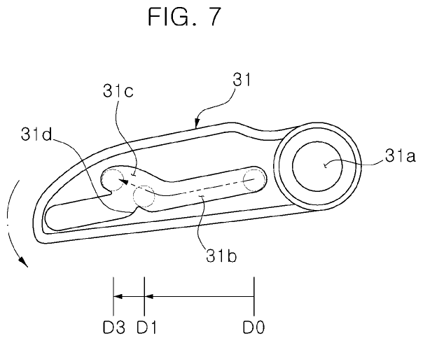

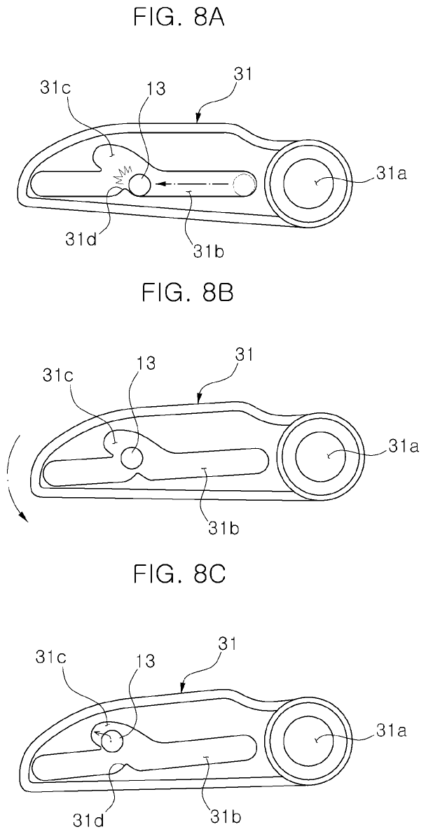

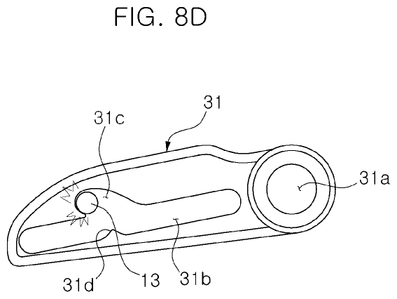

FIG. 4, FIG. 5A, FIG. 5B, FIG. 5C and FIG. 5D, FIG. 6, FIG. 7, FIG. 8A, FIG. 8B, FIG. 8C and FIG. 8D, and FIG. 9 illustrate an example where the door handle assembly 10 operates by the blocking lever 31 mounted on the door handle assembly 10.

First, FIG. 4, FIG. 5A, FIG. 5B, FIG. 5C and FIG. 5D and FIG. 6 illustrate a state of the door handle assembly 10 during normal operation.

In a case where the door handle assembly 10 operates normally, the door handle lever 13 may be moved from the locking position D0, an initial position, inside the operation slot 31b, up to the unlocking position D2 at which the operation is completely performed. Therefore, the door handle assembly 10 operates normally, and thus the door may be opened.

In a case where the occupant operates the door handle assembly 10 to ride in the vehicle, the door handle lever 13 starts to be moved from the locking position D0 on the operation slot 31b toward the unlocking position D2 (refer to FIG. 5A).

At the present point, although the door handle lever 13 reaches the protrusion portion 31d at the branching position D1, a moving speed of the door handle lever 13 may be low, and an amount of rotation of the blocking lever 31 may be insignificant. Because of this, the door handle lever 13 may move through the communicating portion E and move over the protrusion portion 31d (refer to FIGS. 5B and 5C).

The door handle lever 13 passing over the protrusion portion 31d may be moved along the remaining section of the operation slot 31b and may reach the unlocking position D2 (refer to FIG. 5D).

When, in the present manner, the door handle lever 13 may be moved over the protrusion portion 31d and may be moved only inside the operation slot 31b, the door handle 12 may be moved a predetermined distance from the initial position and moves up (refer to FIG. 6). Therefore, the occupant may open the door using the door handle 12.

FIG. 7, FIG. 8A, FIG. 8B, FIG. 8C and FIG. 8D and FIG. 9 illustrate an example where during the collision of the vehicle, the door handle assembly 10 may operate by the blocking lever 31 mounted on the door handle assembly 10.

When the collision energy occurring from the collision of the vehicle is released to the door handle assembly 10, due to the collision energy, the door handle assembly 10 may start to perform an unlocking operation. Accordingly, the door handle lever 13 may start to be moved from the locking position D0 on the operation slot 31b toward the unlocking position D2 (refer to FIG. 8A).

At the same time, during the collision of the vehicle, due to the collision energy, the blocking lever 31 may also start to be rotated. At the present point, the rotation speed and the amount of rotation of the blocking lever 31 may be greater, respectively, than during normal operation.

When the door handle lever 13 reaches the protrusion portion 31d at the branching position D1 inside the operation slot 31b, the rotation speed of the blocking lever 31 and the amount of rotation thereof may be greater, respectively, than during normal operation. Moreover, the moving speed of the door handle lever 13 may also be greater than during normal operation. Therefore, the door handle lever 13 may be moved by the protrusion portion 31d from the operation slot 31b to the blocking slot 31c (refer to FIGS. 8B and 8C).

Subsequently, the door handle lever 13 may reach the blocking position D3 on the blocking slot 31c (refer to FIG. 8D). The blocking position D3 may be closer to the locking position D0 than to the unlocking position D2. Because of this, the door handle lever 13 may not operate to a sufficient extent, and may not cause the door handle 12 to move up fully. Accordingly, the door handle assembly 10 may not completely perform the unlocking operation and thus may be kept continuously locked. Therefore, although the collision occurs, the door is kept closed without being opened.

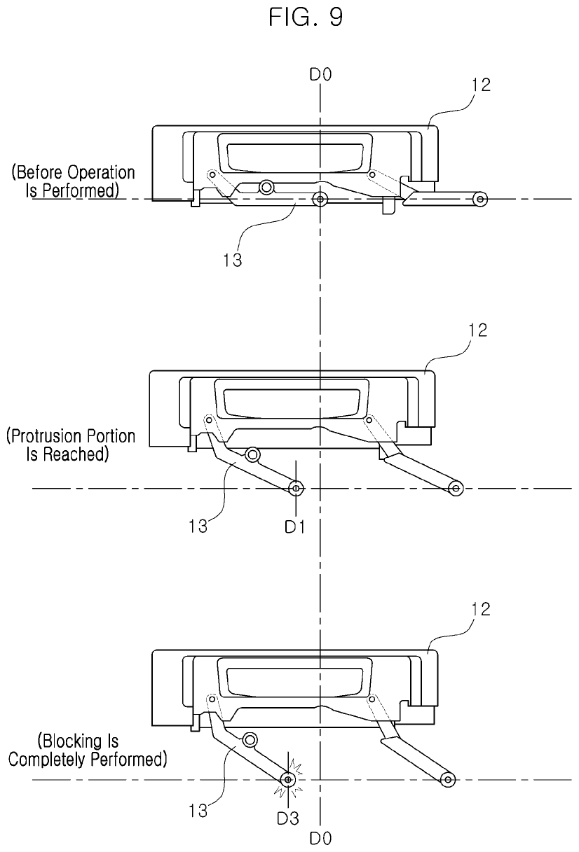

FIG. 10 illustrates a blocking lever 131 according to another exemplary embodiment of the present disclosure.

The blocking lever 131 according to the exemplary embodiment may include the same configurations and operations as shown in FIG. 2, but may be provided in a manner as to be rotated in a clockwise direction (i.e., in a direction of an arrow A′ in FIG. 10) in the door handle assembly 10. Here, the blocking slot 131c is formed to be rotated in the opposite direction thereof. Accordingly, for simplicity, we omit the detailed descriptions on the operation of the blocking lever 131.

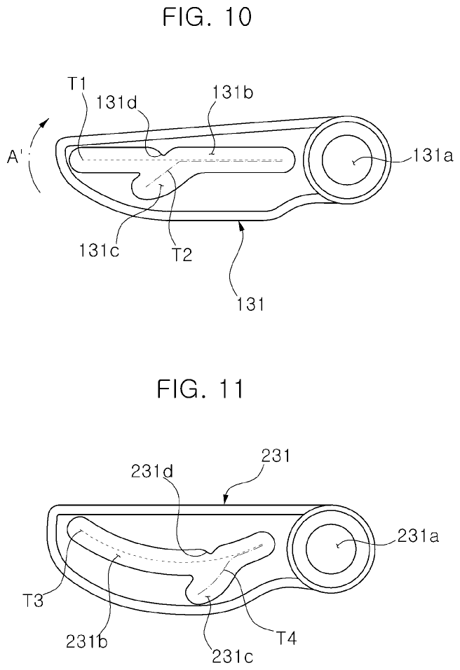

FIG. 11 illustrates a blocking lever 231 according to various exemplary embodiments of the present disclosure.

The blocking lever 231 according to the exemplary embodiment may be used in a door opening and closing apparatus 30 whose constituent element corresponding to the linkage member 13 of the door opening and closing apparatus 30 operates in a rotatable manner.

The hinge connection hole 231a, the operation slot 231b along which the linkage member is moved during normal operation, and the blocking slot 231c branching off from the operation slot 231b may also be formed in the blocking lever 231 according to the exemplary embodiment as in the exemplary embodiment described above. Since the linkage member 13 or a constituent element corresponding thereto operates in a rotatable manner, the operation slot 231b may also be formed so that extends along a curved line, such as a circular arc, and the blocking slot 231c may also be formed so that extends along a curved line.

During the collision of the vehicle, the blocking lever 231 is rotated, and thus the linkage member 13 is moved from the operation slot 231b to the blocking slot 231c. Accordingly, the door opening and closing apparatus may not be completely unlocked, and the blocking slot 231c may keep the door closed.

A third tracking path T3 along which the linkage member 13 is normally moved by the operation slot 231b, and a fourth tracking path T4 along which the linkage member 13 is moved by the blocking slot 231c during the collision are also formed in the blocking lever 231 according to the exemplary embodiment of the present disclosure.

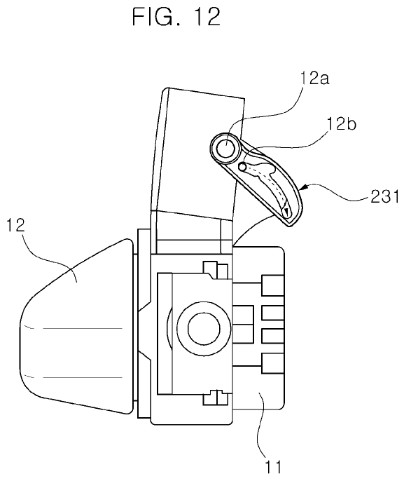

FIG. 12 illustrates an example where the blocking lever 231 illustrated in FIG. 11 is used for the door handle 12 of the door opening and closing apparatus that rotates in a rotatable manner.

The door handle 12 may be provided on the housing 11 such which is rotatable about a rotation shaft 12a.

The blocking lever 231 may be formed on the housing 11 to be rotatable. According to the exemplary embodiment of the present disclosure, the linkage member may be a linkage protrusion 12b which is formed on one side of the door handle 12 to be rotated with the door handle 12.

During normal operation of the door handle 12, the linkage protrusion 12b may be rotated with the door handle 12 and may be moved along the operation slot 231b in the blocking lever 231, and thus the door handle 12 may operate. During the collision of the vehicle, the rotation speed of the blocking lever 231 is high, and thus the linkage protrusion 12b is moved from the operation slot 231b to the blocking slot 231c. Accordingly, the operation of the door handle 12 may be interrupted, and thus the door handle 12 may not be caused to operate completely. Accordingly, a phenomenon where the door is opened during the collision of the vehicle may be prevented.

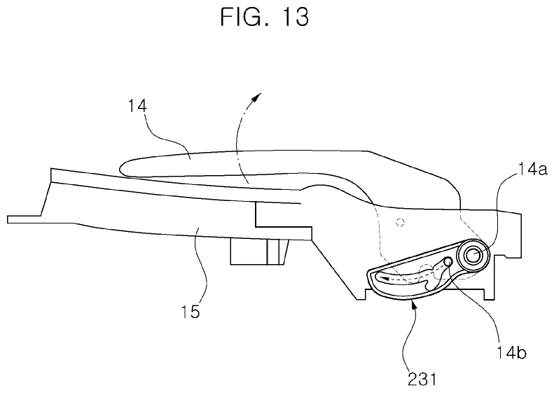

FIG. 13 illustrates an example where the blocking lever 231 illustrated in FIG. 11 is used for a door inside handle 14.

The door inside handle 14 may be rotatably provided on a door trim 15, and the blocking lever 231 may be provided to operate by linkage to the door inside handle 14. That is, the door inside handle 14 may be provided on the door trim 15 such which is rotatable about a rotation shaft 14a. The blocking lever 231 may be also rotatably provided on the rotation shaft 14a. According to the exemplary embodiment of the present disclosure, the linkage member may be another linkage protrusion 14b which is formed on one side of the door inside handle 14.

When the door inside handle 14 is operated, the linkage protrusion 14b is moved along the operation slot 231b in the blocking lever 231 while being rotated with the door inside handle 14. That is, during normal operation of the door inside handle 14, the linkage protrusion 14b may be moved along the operation slot 231b in the blocking lever 231 while being rotated with the door inside handle 14. Accordingly, the door inside handle 14 operates normally. During the collision of the vehicle, the rotation speed of the blocking lever 231 may be high, and thus the linkage protrusion 14b may be moved from the operation slot 231b to the blocking slot 231c. Accordingly, the operation of the door inside handle 14 is interrupted, and thus the door is prevented from being opened.

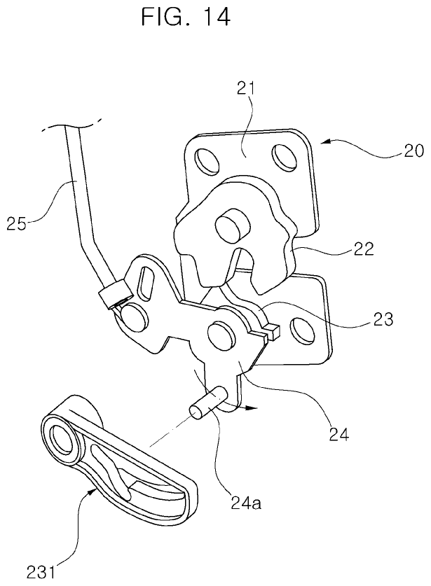

FIG. 14 illustrates an example where the blocking lever 231 illustrated in FIG. 11 is used for a door latch.

The door latch 20 holds a striker securely on a base 21 using a claw 22 and a pole 23 that are rotated and thus keeps the door locked. When an operating force of the door handle 12 or the door inside handle 14 may be transferred to a wire 25, the claw 22 and the pole 23 may operate, releasing the striker. Thus, the door is kept unlocked.

At the present point, the blocking lever 231 is provided to be moved by linkage to a release lever 24 that transfers an operating force of the wire 25 to the pole 23. The blocking lever 231 may be rotatably provided on one side of the base 21 or on a panel of the door, and a linkage pin 24a formed on one side of the release lever 24 may be positioned inside the operation slot 231b. The blocking lever 231 may be linked by the linkage pin 24a to the release lever 24. The blocking lever 231 may be moved as the door latch 20 operates, that is, as the release lever 24 is rotated. According to the exemplary embodiment of the present disclosure, the linkage pin 24a may be the linkage member. Furthermore, the release lever 24 may be the operation member.

During normal operation, when the release lever 24 is rotated, the linkage pin 24a is moved into the operation slot 231b, and thus, the release lever 24 may be completely rotated. Accordingly, the claw 22 and the pole 23 may be operated, and thus the striker may be unlocked.

However, during the collision of the vehicle, a rotation speed of the release lever 24 may be high, and the rotation speed of the blocking lever 231 and the amount of rotation thereof may be increased. Accordingly, the linkage pin 24a, when brought into contact with the protrusion portion 231d while being moved along the operation slot 231b, may be moved from the operation slot 231b to the blocking slot 231c. When the linkage pin 24a is moved to the blocking slot 231c, the release lever 24 may not be completely rotated, and thus the claw 22 and the pole 23 do not hold securely the striker. Accordingly, during the collision of the vehicle, the door may be prevented from being opened.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In the present specification, unless stated otherwise, a singular expression includes a plural expression unless the context clearly indicates otherwise.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A door opening and closing apparatus for a vehicle for preventing a door of the vehicle from opening during a collision, the apparatus comprising:
an operation member configured to operate to open the door, and
a blocking lever engaged to the operation member and configured to limit operating of the operation member during the collision of the vehicle,
wherein the blocking lever includes:
an operation slot formed along which a linkage member operating the operation member and the blocking lever is moved from a locking position to an unlocking position during the collision of the vehicle; and
a blocking slot branched off from the operation slot, wherein during the collision of the vehicle, the blocking lever is configured to be rotated or moved, and the linkage member moves from the operation slot to the blocking slot, so that the blocking lever is blocked from reaching the unlocking position during the collision of the vehicle.

2. The door opening and closing apparatus of claim 1, wherein the blocking slot is formed so that a distance of the blocking lever from the operation slot is increased toward a first side of the blocking lever from a second side of the blocking lever which is hinged to a housing.

3. The door opening and closing apparatus of claim 1, wherein the blocking slot is formed so that an imaginary central axis of the blocking slot is inclined with a predetermined angle with respect to an imaginary central axis of the operation slot.

4. The door opening and closing apparatus of claim 1, wherein the blocking slot is formed so that the blocking slot extends from the operation slot in a direction that moves away therefrom transversely to a rotation direction or a moving direction of the blocking lever.

5. The door opening and closing apparatus of claim 1, wherein the blocking slot branches off from the operation slot so that the blocking slot is positioned behind the operation slot in a situation that the blocking lever is rotated or moved.

6. The door opening and closing apparatus of claim 1, wherein a protrusion portion is formed at a position at which the blocking slot branches off from the operation slot, so that the protrusion portion protrudes toward the blocking slot.

7. The door opening and closing apparatus of claim 6, wherein the protrusion portion is formed on an internal surface of the operation slot that faces an internal surface of the operation slot in which the blocking slot is not formed.

8. The door opening and closing apparatus of claim 6, wherein the protrusion portion is formed so that the protrusion portion is brought into contact with the linkage member in a situation that the linkage member reaches a branching position at which the blocking slot branches off from the operation slot.

9. The door opening and closing apparatus of claim 6, wherein the protrusion portion is formed so that a distance from the protrusion portion to an end portion of the blocking slot is shorter than a distance from the protrusion portion to an end portion of the operation slot.

10. The door opening and closing apparatus of claim 6,
wherein an inclination portion is formed on the protrusion portion, and
wherein the linkage member is moved along the inclination portion from the operation slot to the blocking slot in a situation that the blocking lever is rotated or is moved due to the collision of the vehicle.

11. The door opening and closing apparatus of claim 10, wherein the inclination portion is formed in an inclined manner so that, in a situation that the blocking lever is rotated or is moved, the inclination portion is positioned farther and farther from an internal surface of the operation slot, on which the protrusion portion is formed, along a direction in which the linkage member is moved.

12. The door opening and closing apparatus of claim 10, wherein the inclination portion is formed in parallel with an imaginary central axis of the blocking slot.

13. The door opening and closing apparatus of claim 10,
wherein the inclination portion is formed so that the inclination portion lies on a same line as an imaginary line of a communicating portion or is positioned closer to one side of the blocking lever which is hinged to a housing than the communicating portion, and
wherein the imaginary line of the communicating portion extends from an internal surface, one of internal surfaces of the blocking slot, which supports the linkage member which is moved into the blocking slot.

14. The door opening and closing apparatus of claim 10,
wherein a guiding portion is formed on the protrusion portion, and
wherein the guiding portion is configured for guiding the linkage member to a remaining section of the operation slot after the linkage member is moved through a communicating portion and moved along the inclination portion to an end portion of the inclination portion.

15. The door opening and closing apparatus of claim 10,
wherein the protrusion portion is formed so that a distance between a top portion of the protrusion portion and a portion of an internal surface that meets the operation slot is greater than a diameter of the linkage member, and
wherein the internal surface is one of internal surfaces of the blocking slot and supporting the linkage member which is moved into the blocking slot.

16. The door opening and closing apparatus of claim 1, wherein the operation slot is formed along a tracking path along which the linkage member is moved during normal operation of the door opening and closing apparatus.

17. The door opening and closing apparatus of claim 1,
wherein a hinge connection hole for hinge-connecting the blocking lever to a side of the door opening and closing apparatus is formed in a first side of the blocking lever, and
wherein the operation slot is formed to extend toward a second side of the blocking lever from a position which is spaced a predetermined distance apart away from the hinge connection hole.

18. The door opening and closing apparatus of claim 1, further including
a door handle assembly in which a door handle lever causes a door handle to move up from a housing,
wherein the operation member includes a door handle, and
wherein the linkage member includes a door handle lever.

19. The door opening and closing apparatus of claim 18,
wherein the blocking lever is rotatably or movably provided on the housing, and
wherein the door handle lever is provided to pass through the operation slot.

20. The door opening and closing apparatus of claim 19, wherein during the collision of the vehicle, the door handle lever is moved along the operation slot and is moved from the operation slot to the blocking slot, blocking the door handle from completely being popped upwards.

21. The door opening and closing apparatus of claim 1, further including a door latch which is provided on one side of the door and holds a striker,
wherein the operation member includes a release lever that releases a claw and a pole of the door latch, and
wherein the linkage member includes a linkage pin formed on the release lever to protrudes from the release lever.

22. The door opening and closing apparatus of claim 21,
wherein the blocking lever is rotatably provided on one side of the door latch, and
wherein the linkage pin is provided to pass through the operation slot.

23. The door opening and closing apparatus of claim 22, wherein during the collision of the vehicle, the linkage pin is moved along the operation slot so that the release lever does not unlock the claw and the pole, and is moved from the operation slot to the blocking slot, blocking the release lever from being rotated.

24. The door opening and closing apparatus of claim 1, further including a door handle which is provided on a housing and is rotatable about a rotation shaft,
wherein the linkage member includes a linkage protrusion which is formed on one side of the door handle.

25. The door opening and closing apparatus of claim 1, further including a door inside handle which is rotatably provided on a door trim,
wherein the linkage member includes a linkage protrusion which is formed on one side of the door inside handle.

26. The door opening and closing apparatus of claim 1, wherein each of the operation slot and the blocking slot is formed in a straight line and extends along the blocking lever.

27. The door opening and closing apparatus of claim 1, wherein each of the operation slot and the blocking slot each is formed in a curved line and extends along the blocking lever.
